(19) United States
(12) Patent Application Publication
(10) Pub. No.: US 2013/0264023 A1
(43) Pub. Date: Oct. 10, 2013

(54) LATENT HEAT STORAGE DEVICE WITH PHASE CHANGE MATERIAL AND GRAPHITE MATRIX

(71) Applicants: BASTIAN HUDLER, BAYERDILLING (DE); RAINER SCHMITT, AUGSBURG (DE); BRIAN FORD, GRAYSLAKE, IL (US); WERNER LANGER, HEGNENBACH (DE); SYLVIA MECHEN, MEITINGEN (DE)

(72) Inventors: BASTIAN HUDLER, BAYERDILLING (DE); RAINER SCHMITT, AUGSBURG (DE); BRIAN FORD, GRAYSLAKE, IL (US); WERNER LANGER, HEGNENBACH (DE); SYLVIA MECHEN, MEITINGEN (DE)

(73) Assignee: SGL CARBON SE, WIESBADEN (DE)

(21) Appl. No.: 13/442,091

(22) Filed: Apr. 9, 2012

(51) Int. Cl. F28D 17/00; F27D 3/00

(52) U.S. Cl. 165/10; 432/9

(57) ABSTRACT

A latent heat storage device is formed with a carrier substrate formed of expanded graphite material. Phase change material is infiltrated in the graphite material. A thin graphite sheet provides for the functional heat conductivity into and out of the carrier substrate. After the phase change material (PCM) is infiltrated in the carrier substrate, a density of the infiltrated carrier substrate exceeds its starting density by a ratio of at least 3:1 or 4:1 or more. The volume dimensions of the infiltrated the carrier substrate remain substantially unchanged. In the alternative, the latent heat storage device may also have a PCM coating layer on a thin carrier substrate, wherein the phase change material is interspersed in a carrier matrix forming the PCM coating layer. The composite device may be very thin.

### BACKGROUND OF THE INVENTION

### Field of the Invention

The invention relates to a heat-conducting device, such as heat sinks and similar cooling structures, and to PCM/graphite composite systems.

Phase change materials (PCM) are capable of storing heat energy in the form of latent heat. The heat content is stored primarily by the conversion of the PCM from one phase to another. Most PCMs thereby change between a liquid phase and a solid phase. The heat transferred into or out of the PCM does not change its temperature; it is referred to as latent heat.

Phase change materials are being increasingly used in cooling systems for electronic devices. Within electronic applications, the cooling of devices is realized through to thin metal sheets, graphite foils or thermal conductive gels. Since the space in the application is typically very limited, it is necessary to provide the cooling by way of very thin materials. In order to combine a heat spreading or heat conducting material with some heat storage option, to protect the system against thermal runaway, a space efficient system needs to be developed.

Besides the need for electronic devices the same system may also be utilized as a type of activated cooling element for battery systems, where the heat storage materials are combined with other carbon and graphite materials as construction or heat dissipation material.

The additional materials or structures are primarily provided because the phase change materials typically have very low thermal conductivity. As such, it is technically difficult to conduct the heat into the PCM. Also, the PCM is not structurally rigid, at least in one of its useful phases. The characteristically low thermal conductivity of the PCMs may be overcome by providing additional highly conductive materials, such as carbon or graphite materials.

United States Patent Application Publication US 2007/0175609 A1 describes a vessel with bulk phase change material. A plurality of graphite foils extend into the bulk PCM in order to enable efficient heat flow into and out of the bulk PCM. That system is suitable to large-scale cooling systems, or heat exchange in general. It is not possible to miniaturize the device to such a degree as to render it suitable for electronic device cooling.

U.S. Pat. No. 7,235,301 B2 mixes graphite flakes into the bulk PCM in order to increase the heat conductivity of the material. The orientation of the graphite flakes may be aligned in a given direction, so as to define the best conductivity in the most useful direction of the final product.

Currently, latent heat storage devices based on the PCM/graphite composite principle are limited in their use since their thickness cannot yet be reduced below certain limits and the mechanical stability of the systems can only be assured with considerable difficulty.

### BRIEF SUMMARY OF THE INVENTION

It is accordingly an object of the invention to provide a latent heat storage device based on PCM/graphite composite material which overcomes the above-mentioned disadvantages of the heretofore-known devices and methods of this general type and which provides for more freedom, relative to the prior art, in terms of structural dimensions, thermal conductivity, and heat storage capacity.

With the foregoing and other objects in view there is provided, in accordance with the invention, a latent heat storage device, comprising:

a carrier substrate formed of expanded graphite material, the carrier substrate having given volume dimensions and a given starting density;

a phase change material infiltrated in the carrier substrate in an amount causing a density of an infiltrated the carrier substrate to exceed the given starting density of the carrier substrate by a ratio of at least 3:1, or even 4:1, or even 5:1, while the given volume dimensions of the infiltrated the carrier substrate remain substantially unchanged;

a graphite sheet disposed on a surface of the infiltrated the carrier substrate for providing functional heat conductivity into an out of the carrier substrate.

In accordance with a preferred implementation of the invention, a mass of the phase change material exceeds a mass of the carrier substrate by a ratio of at least 3:1 in the infiltrated device. The ratio may preferably exceed 4:1 and even 5:1.

In a preferred embodiment of the invention, the phase change material (PCM) is a dual phase system having a solid phase and a liquid phase and it exhibits a phase change temperature (i.e. a melting temperature Tₘ) in a range between 30° C. and 70° C. This temperature range is particularly suitable for the cooling of electronic and electrical devices.

With the above and other objects in view there is also provided, in accordance with the invention, a method of producing the latent heat storage device as outlined herein. The method comprises:

placing one or more graphite blank in a reactor space, the graphite blank having a given density;

preheating the graphite blank to a temperature that lies above a melting temperature of the phase change material to be infiltrated; the preheating is effected in a vacuum furnace;

aspirating the phase change material (PCM) in the liquid phase into the reactor space and causing the phase change material (PCM) to infiltrate the graphite blank to form an infiltrated graphite body having a density exceeding the density of the graphite blank by at least 3:1; and

removing the infiltrated graphite body from the reactor space.

After the product has been removed from the reactor, a graphite cover foil is glued onto at least one surface of the infiltrated graphite body. This is best done after cooling and drying by spay adhesive.

With the above and other objects in view there is also provided, in accordance with the invention, a thin sheet latent heat storage device, comprising:

a substantially flat carrier substrate (e.g., graphite, copper foil);

a PCM coating layer formed on the carrier substrate, the PCM coating layer being formed of a carrier matrix (Tylose, PVA; PVDF, GFG) and phase change material dispersed therein; and

a heat conductor foil disposed on the PCM coating layer for increasing a heat conductivity into an out of the PCM coating layer;

wherein a composite thickness of the substrate together with the PCM coating layer and the foil amounts to no more than 3 mm, preferably no more than 2 mm, and preferably even less than 1 mm.

In accordance with an added feature of the invention, the PCM coating layer is formed of a carrier solution including polyvinyl alcohol and units of phase change materials dispersed therein, the phase change materials being formed of microcapsules of a phase change wax encapsulated in a polymer.

In accordance with a concomitant feature of the invention, the carrier substrate is a thin copper sheet and the PCM coating layer is formed of a polymer carrier with graphite powder and units of phase change materials dispersed therein. Here, too, the phase change materials may be formed of microcapsules of a phase change wax encapsulated in a polymer.

One of the principles, therefore, is to provide encapsulated PCMs that are coated on thin graphite foils. In addition a sandwich material of foil/PCM/foil may be manufactured with reduced thicknesses in that the foil and the coating are kept very thin, while keeping the heat conducting properties and the potential for energy storage. The latter parameter, or course, is driven by the capacity of the phase change material.

In the context of highly integrated circuits, desirable framework parameters may be summarized as follows: extremely small installation space of <1 mm component thickness, thermal conductivity in the range of about 500 W/mK, and storage capacity of the latent heat storage device of about 500 kJ/kg in a temperature range of 30-70° C.

Currently, one millimeter appears to be the approximate lower limit for pre-compacted sheets, especially where they are required to exhibit especially low density. Where the graphite forms the skeletal structure of the device, furthermore, the graphite matrix must be stable enough for impregnation, which is effected at relatively high vacuum. The invention described herein provides for new types of PCM/graphite combinations.

The terms “infiltration” and “impregnation” in the context of this description are quite synonymous. The term “infiltration” refers primarily to adhesive forces on a molecular and microscopic level. The graphite substrate has microscopic perforations—measured in a micrometer and sub-millimeter domain—and voids into which the liquid PCM is drawn (e.g., aspirated by a strong vacuum). The PCM, therefore, does not reside in bulk volume within the device.

Other features which are considered as characteristic for the invention are set forth in the appended claims.

Although the invention is illustrated and described herein as embodied in a latent heat storage device with phase change material and graphite, it is nevertheless not intended to be limited to the details shown, since various modifications and structural changes may be made therein without departing from the spirit of the invention and within the scope and range of equivalents of the claims.

The construction of the invention, however, together with additional objects and advantages thereof will be best understood from the following description of the specific embodiment when read in connection with the accompanying drawings.

### BRIEF DESCRIPTION OF THE SEVERAL VIEWS OF THE DRAWING

FIG. 1 is a schematic partial section taken through a composite structure of a latent heat storage device according to the invention;

FIG. 2 is a diagrammatic view showing an impregnation tank with blanks and grid separators;

FIG. 3 is a table referencing several production examples of infiltrated graphite sheets.

### DETAILED DESCRIPTION OF THE INVENTION

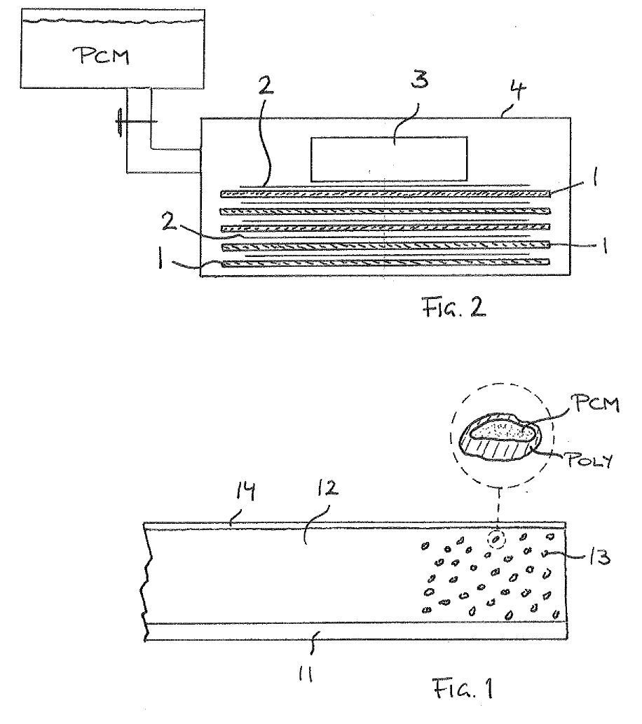

Referring now to the figures of the drawing in detail and first, particularly, to FIG. 1 thereof, there is seen a composite structure of a substrate 11 with a PCM coating 12. The substrate 11 is a thin copper foil (approx. 0.1 mm) and the PCM coating 12 is a compound formed of a carrier matrix with phase-change material micro capsules 13. The capsules 13 are formed by a polymer material that encapsulates an amount of PCM and they have an diameter of approx. 5 μm. As with most PCMs, the encapsulated material is a wax or paraffin-like material (e.g., C₂₂H₄₆). Such microcapsules are available from BASF, Germany, under the tradename Micronal®. The carrier matrix of the coating 12 is formed of a polymer (e.g., PVDF polyvinylidene fluoride), highly-expanded graphite, and a solvent.

A highly conductive cover layer is placed onto the coating 12. This provides for the efficient heat exchange with the PCM coating compound 12.

### PRODUCTION EXAMPLES

### Example 1

### PCM on Copper

4 g of a 5% PVDF solution (vinylidene fluoride polymer) were mixed with 2.3 g of a mixture of Micronal® (PCM, melting temperature ˜25° C., BASF, Germany) and highly expanded graphite (GFG 5) at a ratio of 75% by weight to 25% by weight were mixed together with N-methyl-2-pyrrolidone (2.5 NMP, solvent). The stirring time for the solution was about 1 hour. The mixed solution was coated onto a Cu foil (0.1 mm thick) by means of a doctor blade, the coating thickness being about 250 μm. The coating was subsequently dried at 60° C.

Then, a high-density graphite foil was glued onto the coating, in order to thereby achieve the high thermal conductivity required of such devices. The thickness of the graphite foil was approx. 0.5 mm and its density was 18 g/cm³ (type L05518Z, SGL Carbon SE). The glue application onto the coating was effected by way of spray adhesive.

### Example 2

### PCM on/in Graphite:

First we produced a Tylose solution. Distilled water was introduced into a beaker, and 0.75% Tylose MHB 3000 was slowly interspersed with constant stirring. After a stirring time of about 30 minutes, the mixture was left to stand and swell. A batch of a polyvinyl alcohol (PVA) solution was then produced. To this end, distilled water was heated to about 80-90° C., and then 0.75% Mowiol 588 (PVA) was introduced with constant stirring in a laboratory mixer. After a stirring time of about 30 min, all of the PVA granules had dissolved.

In a next step, the carrier solution was produced from 0.75% Tylose solution and 0.75% PVA solution by mixing. The mixing ratio of the two solutions in this case was 1:1.

A phase change material proportion was then introduced into the carrier solution. We once more used Micronal® (Tₘ=25° C.), here in a ratio 1.75:1 (carrier solution to Micronal®). The phase change material was introduced into the solution with the aid of a stirrer.

Then, the suspension was applied to a thin graphite foil (type F05007Z, SGL Carbon SE) by way of a screen printing process (about 50 g/m²). The graphite foil has a thickness of approx. 0.5 mm and a density of 0.7 g/cm³, that is, it is highly impregnable. Drying took place at room temperature. A high-density graphite foil (type L05518Z, SGL Carbon SE) was then glued onto the coating, by way of spray adhesive, in order to thereby achieve the high thermal conductivity required. The overall thickness of the sandwich was about 1 mm.

Detailed testing of these two types of devices provided promising results. First, we showed that it is possible, in principle, to produce very thin PCM components with a system thickness in the range of 1.0 mm. The exhibited storage capacities and the thermal conductivities attained with these very thin components were quite promising. Even though they did not yet reach the extreme demands listed above (e.g., capacity of 500 kJ/kg and conductivity of 500 W/mK), they are nevertheless suitable for many applications.

The test results of the two types of production samples showed that the storage capacity of the graphite-substrate system lies considerably higher, at about 85 J/g, than that of the copper-substrate system, which reached about 15 J/g. The capacity of the pure starting material PCM was about 110 J/g. It is presumed that the decrease in the storage capacity can be explained by the addition of the solvent, which dissolves the PCM capsules partially and thus negatively impacts the storage capacity of some of the material.

In order to prove the concept and to further improve devices of this kind, we followed further developments and we conducted further investigations:

### Example 3

### Impregnated Graphite

Here, we were concerned with infiltration properties of certain materials. The development was not limited to the extremely thin dimensions of 1 mm, but blanks and the resultant product assemblies were allowed to have thicknesses between 2 and 10 mm. The base system was formed with substrate blanks with high absorption capacity for infiltration with phase change material (PCM) and proper adhesion of a high-density graphite cover foil.

The high-density cover foil may also be provided on both planar surfaces and, indeed, it may be used to encase or encapsulate the entire sandwich structure. The graphite plate or graphite sheet can thereby be formed with very large scale perforations in which the PCM may be infiltrated. In its liquid phase, the phase change material cannot escape from the porous graphite substrate because of the protection afforded by the cover foil.

A variety of different graphite substrates were used for the production of the various samples, as listed in the table of FIG. 2 under “before impregnation.” The graphite plates or sheets are formed of compressed, expanded graphite (EG). As can be seen, the mass ratio of infiltrate to graphite lies well above 3:1 and reaches close to 8:1 in several implementations.

The graphite plates had the general dimensions of 300 mm by 240 mm. The thicknesses varied from 2.0 mm to 10 mm. The densities were also varied between 0.15 and 0.30 g/cm³.

It will be understood that the graphite plates used in the context were/are plates of compressed, expanded graphite (EG).

While a variety of phase change materials (PCMs) are commercially available, we utilized a single source. Here we used a material PureTemp PT 37 manufactured by Entropy Solutions, Inc. of Plymouth, Minn. The PCM has a melting temperature of ˜37° C. and a density in its liquid phase of approximately 0.83 g/cm³. The storage capacity of the PCM was confirmed to be approximately ˜200 J/g.

With reference to FIG. 2, flat graphite blanks 1 were placed and stratified in a tank 4. The blanks 1 were weighted down with weights 3 in order to prevent the samples from floating. Grid separators 2 are indicated between the samples 1. Then, the samples were preheated at a temperature of 50° C. for about 4 h in a vacuum furnace. Before the liquid PCM (temperature 50° C.) could be aspirated in, the furnace had to be evacuated for about two hours (2 h). Then, wet vacuum was applied for a further two hours (2 h), followed by venting of the furnace. After a further 18 hours at standard pressure, it was possible to remove the samples from the bulk PCM.

Following the infiltration/impregnation, the top side or the bottom side of some of the blanks were provided with a high-density graphite foil (type L 029 18 Z, SGL Carbon SE) in order to thereby increase the thermal conductivity in the plane of the plate of the composite material system. The cover foil has a thickness of approx. 0.3 mm and a density of 18 g/cm³. The composite was glued together by way of spray adhesive.

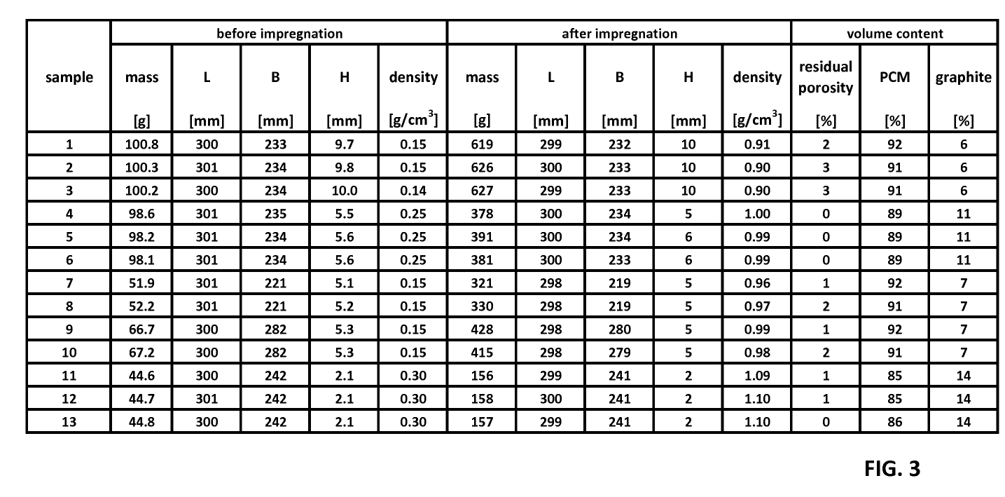

The results of the infiltration were very encouraging. All blanks were surveyed geometrically and weighed before and after the infiltration in order to be able to determine the PCM uptake of the individual samples. The results are shown in the table of FIG. 3.

Of the numbered samples in FIG. 3, samples 3, 4, 7, 13 were each provided with a high-density covering layer.

The volume dimensions (length, width, height) of the starting carrier substrate (prior to infiltration) remain substantially unchanged during the infiltration. Here, a variant of a few percent (e.g., swelling, contraction, unidirectional shearing) is acceptable and lies well within the term “unchanged.”

The infiltration of liquid phase change material is possible without any problems with the parameters used. Further, the production of the composites and the connection between high-density graphite foil and infiltrated blanks was likewise possible without any problems.

1. A latent heat storage device, comprising:
a carrier substrate formed of expanded graphite material, said carrier substrate having given volume dimensions and a given starting density;
a phase change material (PCM) infiltrated in said carrier substrate in an amount causing a density of an infiltrated said carrier substrate to exceed the given starting density of said carrier substrate by a ratio of at least 3:1, while the given volume dimensions of the infiltrated said carrier substrate remain substantially unchanged;
a graphite sheet disposed on a surface of the infiltrated said carrier substrate for providing functional heat conductivity into an out of said carrier substrate.

2. The latent heat storage device according to claim 1, wherein a mass of said phase change material (PCM) exceeds a mass of said carrier substrate by a ratio of at least 3:1.

3. The latent heat storage device according to claim 1, wherein a mass of said phase change material (PCM) exceeds a mass of said carrier substrate by a ratio of at least 4:1.

4. The latent heat storage device according to claim 1, wherein the density of the infiltrated said carrier substrate exceeds the given starting density of said carrier substrate by a ratio of more than 4:1.

5. The latent heat storage device according to claim 1, wherein said phase change material (PCM) is a dual phase system having a solid phase and a liquid phase.

6. The latent heat storage device according to claim 6, wherein said phase change material (PCM) has a phase change temperature in a range between 30° C. and 70° C.

7. A method of producing the latent heat storage device according to claim 1, which comprises:
providing a phase change material (PCM) having a solid phase and a liquid phase, and a given melting temperature;
placing at least one graphite blank in a reactor space, the graphite blank having a given density;
preheating the graphite blank at a temperature above the melting temperature of the phase change material (PCM) in a vacuum furnace;
feeding the phase change material (PCM) in the liquid phase into the reactor space and causing the phase change material (PCM) to infiltrate the graphite blank to form an infiltrated graphite body having a density exceeding the density of the graphite blank by at least 3:1; and
removing the infiltrated graphite body from the reactor space.

8. The method according to claim 7, which further comprises gluing a graphite cover foil onto at least one surface of the infiltrated graphite body.

9. The method according to claim 7, which comprises placing a plurality of substantially flat plates of graphite blanks in stratified order in the reactor space and infiltrating a plurality of graphite plates.

10. A latent heat storage device, comprising:
a substantially flat carrier substrate;
a PCM coating layer formed on said carrier substrate, said PCM coating layer being formed of a carrier matrix and phase change material dispersed therein; and
a heat conductor foil disposed on said PCM coating layer for increasing a heat conductivity into an out of said PCM coating layer;
wherein a composite thickness of said substrate together with said PCM coating layer and said foil amounts to no more than 3 mm.

11. The latent heat storage device according to claim 10, wherein said carrier substrate is a sheet of graphite material having a thickness of less than 1 mm and said heat conductor foil is a graphite sheet.

12. The latent heat storage device according to claim 10, wherein said composite thickness amounts to no more than 2 mm.

13. The latent heat storage device according to claim 10, wherein said composite thickness amounts to no more than 1 mm.

14. The latent heat storage device according to claim 10, wherein said PCM coating layer is formed of a carrier solution including polyvinyl alcohol and units of phase change materials dispersed therein, said phase change materials being formed of microcapsules of a phase change wax encapsulated in a polymer.

15. The latent heat storage device according to claim 10, wherein said carrier substrate is a thin copper sheet and said PCM coating layer is formed of a polymer carrier with graphite powder and units of phase change materials dispersed therein, said phase change materials being formed of microcapsules of a phase change wax encapsulated in a polymer.
